(19) United States
(12) Patent Application Publication
(10) Pub. No.: US 2024/0193840 A1
(43) Pub. Date: Jun. 13, 2024

(54) ORDERING AN AVATAR IN A VIRTUAL ENVIRONMENT

(71) Applicant: Orange, Issy-les-Moulineaux (FR)

(72) Inventors: Fabrice BOUDIN, CHATILLON CEDEX (FR); Arnaud BRUN, CHATILLON CEDEX (FR)

(21) Appl. No.: 18/535,381

(22) Filed: Dec. 11, 2023

(30) Foreign Application Priority Data
Dec. 13, 2022 (FR) 2213252

(51) Int. Cl. G06T 13/40; G06F 3/01

(52) U.S. Cl. CPC G06T 13/40; G06F 3/011

(57) ABSTRACT

A method for controlling an avatar in a virtual environment is described. In this method, in the absence of human intervention to animate the avatar via a control interface, a control device, triggers at least one action of the avatar in the virtual environment. This action is selected from among a first group of actions learned beforehand during a period of time in which the avatar or another avatar was animated via a control interface by at least one user in said virtual environment, or among a second group of actions digitally modelled based on learning actions executed by at least one user in a real environment corresponding to the virtual environment.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Technical Field

The disclosed technology relates to animation of one or more avatars in the metaverse (contraction of “meta universe”) and more particularly to a method and device for controlling an avatar in a virtual environment or space of the metaverse, in the absence of human intervention to control this avatar.

### Description of the Related Art

At the current time, by virtue of the increasing development of virtual-reality technologies, it is possible, using a computer-like machine incorporating one or more dedicated software packages, to digitally simulate various real environments, spaces or worlds, in such a way that a user is able to have an experience of total immersion and to carry out a senso-motor activity in these various virtual environments as though she or he were in a real environment, space or world. Certain virtual environments host a community of users present in the form of avatars that are able to move, interact, and perform various actions in one or more of these virtual environments. The representation of a virtual environment is generally in three dimensions. Such a virtual environment is accessible and changeable via 3D interactions controlled via a human-machine interface that the user, as a natural person, manipulates in the real environment to, for example, animate her or his avatar in the virtual environment, which is modeled in the form of a two-dimensional or three-dimensional space, for example by moving her or his avatar, by making it interact with another avatar, by making it speak, by making it express an emotion, etc. Such a human-machine interface may be a controller, the keyboard of a computer, a communication terminal, a virtual reality headset, a speaker, etc.

Multiple virtual environments may co-exist. Virtual worlds are generally persistent, i.e. they never cease to exist. Many different settings may be generated in these virtual environments, the settings generated depending on the envisioned applications. For example, in the field of gaming or entertainment, a virtual environment may for example represent a city in which a treasure hunt has been organized. According to another example, in the field of real estate, a virtual environment may for example represent an apartment bought off-plan and in which an avatar of the purchaser of this apartment may interact during, before or after its construction. According to yet another example, in the field of learning, for example learning to drive, a virtual environment may for example represent a road on which a car is approaching a crossroads, the car being driven by an avatar of the learner driver.

Given the increasing number of these virtual environments of various types, it should be clear that a user, a natural person, may have N different avatars representing her or him in N different virtual environments respectively.

Management, potentially simultaneously, of all these avatars (e.g. movement thereof, interaction with other avatars, performance of other actions, etc.), may become very time-consuming, tedious and complicated for the user. For example, in the field of a multiplayer game set in a particular virtual environment, and in which an avatar of the user is participating, it is possible for the game to take place day and night, without interruption. Thus, each player animates her or his avatar as and when she or he is available, at certain times of the day or night, the users potentially being located physically in various geographical locations, and potentially in different time zones. As a result, an avatar of a given user in a given virtual environment cannot be constantly animated by that user, for example when the latter is engaged in another activity (work, sport, rest, etc.) in the real world. At these times when the user is engaged in another activity, the avatars of other players may, for their part, be animated by these other players. So, for example, when an avatar of the user engaged in another activity is attacked by another player's avatar in the virtual environment, the avatar of the user engaged in another activity is not immediately animated to respond to the attack carried out by the other player's avatar. Thus, when the user reconnects to the virtual environment, the user must readjust to regain control of her or his avatar in the virtual environment, in which the situation has changed during the time the user was engaged in her or his other activity. Such readjustment is especially tedious if the user has N avatars in N virtual environments, likely to require N different readjustments. Thus, current virtual-reality applications are not sufficiently developed technically to be completely satisfactory from a use and performance point of view.

Furthermore, it will be noted that, in the field of industry, the development of virtual-reality applications, although growing, remains very limited to certain sectors, such as computer-aided design or maintenance for example. However, it could be useful, for example with a view to controlling costs or risk of reproducibility, to develop these virtual-reality applications in other sectors of industry, in particular that of testing a particular product or service.

### SUMMARY

One of the aims of the disclosed technology is to remedy the drawbacks of the aforementioned approachees by providing a method for controlling an avatar in a virtual environment, said method being executed autonomously, i.e. without intervention by a user to animate the avatar using a human-machine interface.

To this end, one subject of the disclosed technology relates to a method for controlling an avatar, in a virtual environment, characterized in that in the absence of human intervention to animate the avatar via a control interface, the method, in a control device, triggers at least one action of the avatar in the virtual environment, said at least one action being selected:
among a first plurality of actions learned beforehand during a period of time in which the avatar or another avatar was animated by at least one user in said virtual environment, via a control interface,
or among a second plurality of actions digitally modeled based on learning actions executed by at least one user in a real environment corresponding to the virtual environment.

By virtue of such an avatar control method, based on learning actions executed either in a virtual environment, or in a real environment corresponding to the virtual environment, an avatar is thus able to act autonomously in a given virtual environment, without any particular intervention of a user or in the absence of a user responsible for animating this avatar.

A virtual environment is an environment that is simulated digitally using a virtual-reality device, in which one or more avatars are able to move and interact with this environment.

According to one particular embodiment,
the first plurality of actions comprises a type of movement of the avatar or other avatar, or an interaction of the avatar or other avatar with an object or with yet another avatar, or a manifestation of a personality type of the user of the avatar or other avatar,
said second plurality of actions comprises actions taken during use, by at least one user, of a data communication service.

Such an embodiment allows the avatar, when it is acting autonomously, to be provided with an enriched set of actions, which it is able to execute in accordance with the type of virtual environment in which this avatar is located.

According to another particular embodiment, the personality type of the user is identified based on at least one message generated by the user via at least one communication terminal.

Such an embodiment makes it possible to qualify the personality of the user of the avatar in the real environment by exploiting information contained in messages that the user posts or sends via at least one communication terminal. The database of learnt actions on which the control method of the disclosed technology is based is thus advantageously enriched with actions corresponding to digital/graphical models of manifestations of the avatar's personality in the real environment, which are transposable to the virtual environment. If, for example, the user regularly posts aggressive messages on a social network, the aggressiveness of this user will be modeled digitally and/or graphically, then applied to the avatar of this user in the virtual environment, for example in the form of an avatar baring its fists, clenching it teeth, that is surrounded by lightning, etc. According to another example, the graphic behavior of the avatar of a recognized aggressive user may be modified. For example, in a virtual fighting game (game in which several players compete, each via her or his avatar), an “aggressive” avatar, i.e. an avatar in which aggressiveness has been instilled, will attack any avatar passing nearby, while a “non-aggressive” avatar will only defend itself, i.e. respond to any attacks by other avatars, but will never initiate an attack.

According to another particular embodiment, accomplishment of said at least one triggered action of the avatar is recorded digitally.

Such an embodiment makes it possible to keep a digital record or a history of the various actions executed by the avatar autonomously, with a view to subsequently analyzing them, for example to detect certain anomalies, problems or errors in the accomplishment of the actions executed in the virtual environment, and thus implement corrections and/or updates to the scenario executed in the virtual environment.

According to another particular embodiment, for a given user, said at least one action of the avatar is triggered in relation to an event that occurred in the virtual environment, said at least one action being selected:
from a first group of actions of the first plurality of actions, the actions of the first group having already been executed in relation to an event similar to the event that occurred,
from a second group of actions of the second plurality of actions, the actions of the second group resulting from digital modeling of actions executed in a real environment in relation to an event similar to the event that occurred.

Such an embodiment makes it possible to implement a particularly well targeted selection of the action to be implemented by the avatar, such a selection further being consistent with the event that occurred.

According to another particular embodiment, said at least one selected action is an action, of the first plurality of actions or second plurality of actions respectively, that has been identified beforehand as a favorite action.

Such an embodiment makes it possible to implement a selection of the action to be implemented by the avatar based on a preference criterion.

According to another particular embodiment, said at least one action is randomly selected among the first plurality of actions or second plurality of actions respectively.

Such an embodiment makes it possible to implement a random selection of the action. Such a random selection is particularly relevant, for example, when no particular event occurs in the virtual environment, when no action, of the first plurality of actions or of the second plurality of actions respectively, is relevant to the avatar's situation in the virtual environment, or when the control device decides to modify the usual behavior of the avatar, in order to surprise another avatar present in the virtual environment and likely to interact with the avatar, etc.

The various aforementioned embodiments or features may be added, independently or in combination with one another, to the method for controlling an avatar defined above.

The disclosed technology also relates to a device for controlling an avatar in a virtual environment, characterized in that it is configured to trigger, in the absence of human intervention to animate the avatar via a control interface, at least one action of the avatar in the virtual environment, said at least one action being selected:
among a first plurality of actions learned beforehand during a period of time in which the avatar or another avatar was animated by at least one user in said virtual environment, via a control interface,
or among a second plurality of actions digitally modeled based on learning actions executed by at least one user in a real environment corresponding to the virtual environment.

The disclosed technology also relates to a computer program comprising instructions for implementing the method for controlling an avatar according to the disclosed technology, according to any one of the particular embodiments described above, when said program is executed by a processor.

Such instructions may be stored durably in a non-transient memory medium of the avatar-control device implementing the method for controlling an avatar according to the disclosed technology.

This program may use any programming language and take the form of source code, object code or code intermediate between source code and object code, such as code in a partially compiled form, or in any other desirable form.

The disclosed technology also targets a computer-readable storage medium or data medium containing instructions of a computer program such as mentioned above.

The storage medium may be any entity or device capable of storing the program. For example, the medium may comprise a storage means, such as a ROM, for example a CD-ROM or a microelectronic circuit ROM, or a magnetic storage means, for example a mobile medium, a hard disk or an SSD.

Furthermore, the storage medium may be a transmissible medium such as an electrical or optical signal, which may be routed via an electrical or optical cable, by radio or by other means, such that the computer program that it contains is able to be executed remotely. The program according to the disclosed technology may in particular be downloaded from a network, for example an IP network such as the Internet.

Alternatively, the storage medium may be an integrated circuit into which the program is integrated, the circuit being configured to execute or to be used in the execution of the aforementioned method for controlling an avatar.

According to one example of embodiment, the present technique is implemented by means of software components and/or hardware components. With this in mind, the term “device” or “module” may correspond in this document equally to a software component, to a hardware component or to a set of software components and hardware components.

### BRIEF DESCRIPTION OF THE DRAWINGS

Other features and advantages will become apparent on reading particular embodiments of the disclosed technology, which are given by way of illustrative and non-limiting examples, and the appended drawings.

FIG. 1A shows an architecture in which the method for controlling an avatar is implemented, according to one particular embodiment of the disclosed technology

FIG. 1B shows an architecture in which the method for controlling an avatar is implemented, according to one particular embodiment of the disclosed technology.

FIG. 2A shows a device for controlling an avatar, according to one particular embodiment of the disclosed technology, such as implemented in the architecture of FIG. 1A.

FIG. 2B shows a device for controlling an avatar, according to one particular embodiment of the disclosed technology, such as implemented in the architecture of FIG. 1B.

FIG. 3A shows an artificial-intelligence module, according to one particular embodiment of the disclosed technology, such as implemented in the architecture of FIG. 1A.

FIG. 3B shows an artificial-intelligence module, according to one particular embodiment of the disclosed technology, such as implemented in the architecture of FIG. 1B.

FIG. 4A shows the main actions implemented in the avatar-control method according to one particular embodiment of the disclosed technology, such as implemented in the architecture of FIG. 1A.

FIG. 4B shows the main actions implemented in the avatar-control method according to one particular embodiment of the disclosed technology, such as implemented in the architecture of FIG. 1B.

### DETAILED DESCRIPTION

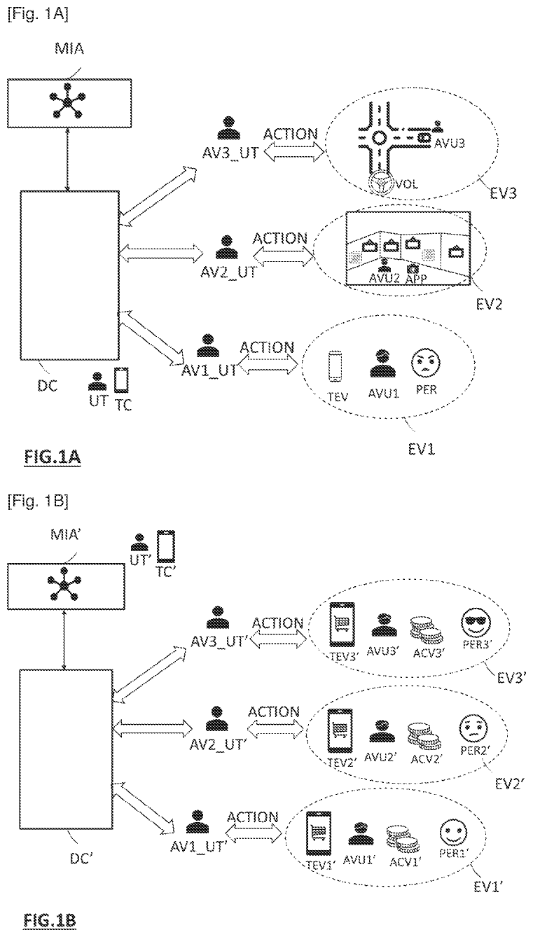

FIG. 1A shows an architecture in which a method for controlling at least one avatar according to a first embodiment of the disclosed technology is implemented. In the example shown, N different virtual environments, with N>1, have been shown, for example three environments EV1, EV2, EV3. In the virtual environments EV1, EV2, EV3 such control is applied to avatars AV_UT1, AV_UT2, AV_UT3 of the same user UT, respectively. The virtual environment EV1 is for example a video game in which the avatar AV_UT1 is involved as a player. The virtual environment EV2 is for example a virtual museum in which the avatar AV_UT2 is involved as a visitor to this museum. The virtual environment EV3 reproduces for example a road on which the avatar AV_UT3 is driving, in the context for example of learning how to drive an automobile.

According to the disclosed technology, each of these avatars AV_UT1, AV_UT2, AV_UT3 is controlled not by means of a human-machine interface manipulated by the user of these avatars, but automatically by a control device DC that will be described further on in the description.

More precisely, such a control device DC is configured to automatically apply actions to the avatar AV_UT1 (AV_UT2, AV_UT3 respectively) in its virtual environment EV1 (EV2, EV3 respectively), in the absence of any intervention by the user to control or animate these avatars with a human-machine interface.

By way of non-exhaustive examples, the type of actions/activities controlled by the control device DC comprises:
a physical action of the avatar AV_UT1 (AV_UT2, AV_UT3 respectively),
an interaction of the avatar AV_UT1 (AV_UT2, AV_UT3 respectively) with a virtual object,
an interaction of the avatar AV_UT1 (AV_UT2, AV_UT3 respectively) with another avatar, for example AVU1 (AVU2, AVU3 respectively),
a particular personality type of the user of the avatar, for example a level of open-mindedness, a level of extroversion, a level of empathy,
etc.

In the example of FIG. 1A:
a physical action of the avatar AV_UT1 (AV_UT2, AV_UT3 respectively) with a virtual object may for example be:
in the case of the virtual environments EV1, EV2, various types of possible movements executed by the avatar AV_UT1, AV_UT2 respectively (e.g.: crouching, standing up, extending its arms, running, turning its head to the right, bending forward, etc.),
in the case of the virtual environment EV3, turning its head to one side or the other, opening its eyes wide, etc.,
an interaction of the avatar AV_UT1 (AV_UT2, AV_UT3 respectively) with a virtual object may for example be:
in the case of the virtual environment EV1, an interaction of the avatar AV_UT1 with a virtual interface of a virtual smartphone TEV in order for example to search for content using one or more keywords, to watch a movie, to purchase a product online, to listen to streamed music, etc.,
in the case of the virtual environment EV2, an interaction of the avatar AV_UT2 with a virtual camera to photograph the virtual paintings of the visited virtual museum, etc.,
in the case of the virtual environment EV3, an interaction of the avatar AV_UT3 with a virtual steering wheel VOL of a virtual automobile, etc.,
an interaction of the avatar AV_UT1 (AV_UT2, AV_UT3 respectively) with another avatar may for example be:
in the case of the virtual environment EV1, an interaction of the avatar AV_UT1 with another avatar AVU1 present in the virtual environment EV1, said interaction being able to be implemented in the context for example of a fighting game, a game of hide-and-seek involving the avatars AV_UT1 and AVU1, etc.,
in the case of the virtual environment EV2, an interaction of the avatar AV_UT2 with another avatar AVU2 present in the virtual environment EV2, said interaction being able to be implemented in the context for example of a virtual discussion between the avatar AV_UT2, in its role as a visitor to the museum, and the avatar AVU2, in its role as a guide in this virtual museum,
in the case of the virtual environment EV3, an interaction of the avatar AV_UT3 with another avatar AVU3 present in the virtual environment EV3, for example a collision between the virtual automobile driven by the avatar AV_UT3 and the virtual automobile driven by the avatar AVU3, a virtual altercation, a virtual discussion, etc. between the avatar AV_UT3 and the avatar AVU3,
a particular personality type of the user of the avatar AV_UT1 (AV_UT2, AV_UT3 respectively) which may be modeled, for example, in the case of the avatar AV_UT1, in the form of an icon PER representative of this personality type (e.g.: the icon smiles if the user of the avatar is a calm person, the icon pouts if the user of the avatar is a reserved person, etc.), or of a modification of the avatar depending on the personality trait corresponding thereto (e.g.: in the case of cheerfulness, the avatar smiles, in case of stress, the avatar shakes, in the case of open-mindedness, the avatar opens its arms with a smile, etc.).

The control device DC may be placed in an appliance or a terminal that renders the virtual environment, for example a computer, a virtual-reality headset, a smartphone, etc., or be connected to this appliance or terminal by any suitable means of communication.

The control device DC is further configured to communicate/interact, via any suitable means of communication, with an artificial-intelligence module MIA responsible for learning the various actions and interactions of the avatars AV_UT1, AV_UT2, AV_UT3 and/or their respective personality traits, in a period of time during which these avatars are animated by the user in their respective virtual environments, using a human-machine control interface.

FIG. 1B shows an architecture in which a method of controlling at least one avatar according to a second embodiment of the disclosed technology is implemented. In the example shown, N different virtual environments, with N>1, have been shown, for example three environments EV1′, EV2′, EV3′. Each of these virtual environments models a usage scenario executed in the context of use of a virtual data-communication service. In the example shown, such a service is the purchase of a product or service using a smartphone or any other suitable communication terminal (e.g. tablet, smart watch, etc.). It could of course be a question of other types of service, for example a service allowing content to be downloaded, a service providing job-interview simulations, etc.

In the virtual environments EV1′, EV2′, EV3′ such control is applied to an avatar AV_UT1′, AV_UT2′, AV_UT3′, respectively. These avatars may represent the same user UT′ or different real-world users who have previously used this service in real life. These avatars may also be created from scratch and not be attached to a particular user who has previously used this service in real life.

According to the disclosed technology, each of these virtual environments EV1′, EV2′, EV3′ is a digital model of a real environment in which users have been confronted in real life with the need to use the data-communication service.

To this end, each of the virtual environments EV1′, EV2′, EV3′ is similar. In the example shown, the virtual environment EV1′ (EV2′, EV3′ respectively) represents an avatar AV_UT1′ (AV_UT2′, AV_UT3′ respectively) in the process of purchasing a product or service ACV1′ (ACV2′, ACV3′ respectively) using its smartphone TEV1′ (TEV2′, TEV3′ respectively).

According to the disclosed technology, each of these avatars AV_UT1′, AV_UT2′, AV_UT3′ is controlled not by means of a human-machine interface manipulated by the user of these avatars, but automatically by a control device DC′ of a type similar to the aforementioned control device DC.

More precisely, such a control device DC′ is configured to automatically apply actions to the avatar AV_UT1′ (AV_UT2′, AV_UT3′ respectively) in its respective virtual environment EV1′ (EV2′, EV3′ respectively), in the absence of any intervention by the user to control or animate these avatars with a human-machine interface.

By way of non-exhaustive examples, the type of actions/activities controlled by the control device DC′ comprises:
a physical action of the avatar AV_UT1′ (AV_UT2′, AV_UT3′ respectively), such as for example a particular movement (e.g.: moving its fingers to type a code, bending to pick up the object to be purchased, frowning, etc.),
an interaction of the avatar AV_UT1′ (AV_UT2′, AV_UT3′ respectively) with a virtual object, for example a virtual smartphone TEV1′ (TEV2′, TEV3′ respectively) or a virtual product or service ACV1′ (ACV2′, ACV3′ respectively),
an interaction of the avatar AV_UT1′ (AV_UT2′, AV_UT3′ respectively) with another avatar AVU1′ (AVU2′, AVU3′ respectively), such as for example a salesperson, a customer or a security guard of the shop in which the virtual object ACV1′ (ACV2′, ACV3′ respectively) is located, etc.,
a particular personality type of the user of the avatar or assigned to the avatar, for example a level of open-mindedness, a level of extroversion, a level of empathy,
etc.

In the example shown, such a personality type has been represented in the form of an icon PER1′ (PER2′ and PER3′ respectively). The icon PER1′ is for example representative of a calm and extroverted personality. The icon PER2′ is for example representative of an anxious and introverted personality. The icon PER3′ is for example representative of a personality assigned to an extroverted visually impaired person. In other examples, the icon PER1′ (PER2′ and PER3′ respectively) may be replaced by or enriched with a modification of the avatar depending on the personality trait corresponding thereto (e.g.: in the case of cheerfulness, the avatar smiles, in the case of stress, the avatar shakes, in the case of open-mindedness, the avatar opens its arms with a smile, etc.).

The control device DC′ may be placed in an appliance or a terminal that renders the virtual environment, for example a computer, a virtual-reality headset, a smartphone, etc., or be connected to this appliance or terminal by any suitable means of communication.

The control device DC′ is further configured to communicate/interact, via any suitable means of communication, with an artificial-intelligence module MIA′ responsible for:
modeling digitally the various actions and/or interactions and/or character/personality traits of the users represented or not by these avatars and having used the smartphone payment service in real life in respective real environments, and possibly
learning the various actions and interactions of the avatars AV_UT1′, AV_UT2′, AV_UT3′ and/or their respective personality traits, in a period of time during which these avatars used the smartphone payment service in their respective virtual environments EV1′, EV2′, EV3′.

In the two embodiments that were described above with reference to FIGS. 1A and 1B, the control devices DC and DC′ are distinct from the artificial-intelligence modules MIA and MIA′, respectively. Of course, according to another embodiment, the control device DC and the artificial-intelligence module MIA, and the control device DC′ and the artificial-intelligence module MIA′, respectively, may form a single entity.

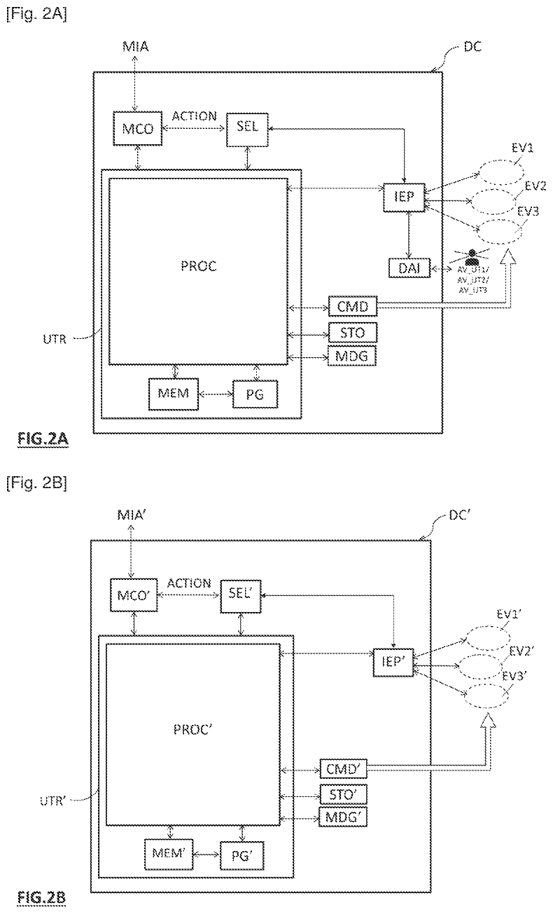

The simplified structure of the aforementioned control device DC will now be described with reference to FIG. 2A.

Such a control device DC comprises:
a communication interface MCO configured to communicate, via a suitable communication network RC, with the artificial-intelligence module MIA,
a module DAI for determining that the user is not interacting with her or his avatar using a human-machine interface,
a module IEP for identifying elements present in the virtual environments EV1, EV2, EV3,
a module SEL for selecting, based on the identified elements, at least one action among a plurality of actions learned by the artificial-intelligence module MIA, in a period of time:
during which the avatars AV_UT1, AV_UT2, AV_UT3 were animated by the user in the respective virtual environments EV1, EV2, EV3, via a control interface,
during which other avatars (not shown) were animated by other users in the respective virtual environments EV1, EV2, EV3, via a control interface,
a module MDG for modeling graphically a personality type assigned to the avatar AV_UT1 and/or AV_UT2 and/or AV_UT3,
a module CMD for automatically controlling the avatars AV_UT1, AV_UT2, AV_UT3,
a memory STO in which the elements identified in the virtual environments EV1, EV2, EV3 and the personality type and/or types modeled graphically may be stored.

In the example shown, such a memory STO is installed in the control device DC. Alternatively, the memory STO may be made accessible by the control device DC depending on the envisioned implementation, for example if it does not have the hardware and software resources required to store this information.

This information is stored in the memory STO for each of the environments EV1, EV2, EV3 in question.

According to one particular embodiment of the disclosed technology, the actions executed by the control device DC are implemented by instructions of a computer program PG. To this end, the device DC has the conventional architecture of a computer and in particular comprises a memory MEM, and a processing unit UTR, which is for example equipped with a processor PROC and controlled by the computer program PG stored in the memory MEM. The computer program PG contains instructions for performing the actions of:
communicating with the artificial-intelligence module MIA,
determining that the user is not interacting with her or his avatar using a human-machine interface,
identifying elements present in the virtual environments EV1, EV2, EV3,
selecting, based on the identified elements, at least one action among a plurality of actions learned by the artificial-intelligence module MIA,
automatically controlling the avatars AV_UT1, AV_UT2, AV_UT3,
graphically modeling a personality type assigned to the avatar AV_UT1 and/or AV_UT2 and/or AV_UT3,
storing the elements identified in the virtual environments EV1, EV2, EV3, and the personality type and/or types modeled graphically, in the context of the method for autonomously controlling an avatar that will be described below, when the program is executed by the processor PROC, according to any one of the particular embodiments of the disclosed technology.

On initialization, the code instructions of the computer program PG are for example loaded into a RAM (i.e. a random-access memory) (not shown) before being executed by the processor PROC. The processor PROC of the processing unit UTR in particular implements the aforementioned actions, according to the instructions of the computer program PG.

The simplified structure of the aforementioned control device DC′ will now be described with reference to FIG. 2B.

Such a control device DC′ comprises:
a communication interface MCO′ configured to communicate, via a suitable communication network RC′, with the artificial-intelligence module MIA′,
a module IEP′ for identifying elements present in the virtual environments EV1′, EV2′, EV3′,
a module SEL′ for selecting, based on the identified elements, at least one action among a plurality of actions learned by the artificial-intelligence module MIA′, during a period of time in which one or more users used the smartphone payment service in a real-life situation,
a module MDG′ for modeling graphically a personality type assigned to the avatar AV_UT1′ and/or AV_UT2′ and/or AV_UT3′,
a module CMD′ for automatically controlling the avatars AV_UT1′, AV_UT2′, AV_UT3′,
a memory STO′ in which the elements identified in the virtual environments EV1′, EV2′, EV3′ and the personality type and/or types modeled graphically may be stored.

In the example shown, such a memory STO′ is installed in the control device DC′. Alternatively, the memory STO′ may be made accessible by the control device DC′ depending on the envisioned implementation, for example if it does not have the hardware and software resources required to store this information.

This information is stored in the memory STO′ for each of the environments EV1′, EV2′, EV3′ in question.

According to one particular embodiment of the disclosed technology, the actions executed by the control device DC′ are implemented by instructions of a computer program PG′. To this end, the device DC′ has the conventional architecture of a computer and in particular comprises a memory MEM′ and a processing unit UTR′, which is for example equipped with a processor PROC′ and controlled by the computer program PG′ stored in the memory MEM′. The computer program PG′ comprises instructions for performing the actions:
communicating with the artificial-intelligence module MIA′,
identifying elements present in the virtual environments EV1′, EV2′, EV3′,
selecting, based on the identified elements, at least one action among a plurality of actions learned by the artificial-intelligence module MIA′,
automatically controlling the avatars AV_UT1′, AV_UT2′, AV_UT3′,
graphically modeling a personality type assigned to the avatar AV_UT1′ and/or AV_UT2′ and/or AV_UT3′,
storing the elements identified in the virtual environments EV1′, EV2′, EV3′ and the personality type and/or types modeled graphically, in the context of the method for autonomously controlling an avatar that will be described below, when the program is executed by the processor PROC′, according to any one of the particular embodiments of the disclosed technology.

On initialization, the code instructions of the computer program PG′ are for example loaded into a RAM (not shown) before being executed by the processor PROC′. The processor PROC′ of the processing unit UTR′ in particular implements the aforementioned actions, according to the instructions of the computer program PG′.

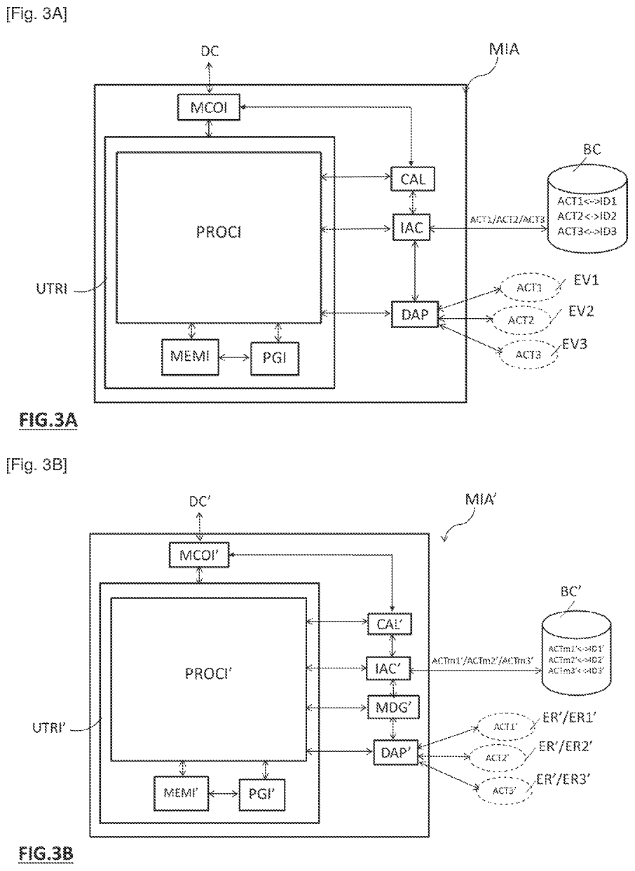

The simplified structure of an artificial-intelligence module MIA used in the system for autonomously controlling an avatar according to the disclosed technology, and as shown in FIG. 1A, will now be described with reference to FIG. 3A.

Such a device MIA comprises:
a communication interface MCOI configured to receive, from the control device DC, at least one request to select an action to be applied autonomously to the avatars AV_UT1, AV_UT2, AV_UT3, and to send a response to this request,
a device DAP for learning a plurality of actions ACT1, ACT2, ACT3 executed by the avatars AV_UT1, AV_UT2, AV_UT3 or other avatars in the respective virtual environments EV1, EV2, EV3, respectively, during an optionally predefined period of time in which the avatars AV_UT1, AV_UT2, AV_UT3 were animated by the user using a human-machine interface or other avatars, for example AVU1, AVU2, AVU3, were animated by one or more different users using a human-machine interface,
a knowledge base BC that is configured to store, in a structured manner, the various learned actions ACT1, ACT2, ACT3 in association with identifiers ID1, ID2, ID3 of the virtual environments EV1, EV2, EV3, respectively,
an interface IAC for accessing the knowledge base BC,
a computing device CALI that is configured to determine the most relevant action in relation to the current context of the virtual environment EV1 (EV2, EV3 respectively), which is detected in the action-selection request received from the control device DC.

Although in the example shown, the knowledge base BC is not contained in the artificial-intelligence module MIA, it may be integrated into said module if it has sufficient hardware and software resources.

By way of non-exhaustive examples, the artificial-intelligence module may be a neural network, be based on deep-learning technology, be based on statistical-learning technology, etc.

According to one particular embodiment of the disclosed technology, the actions executed by the artificial-intelligence module MIA are implemented by instructions of a computer program PGI. To this end, the module MIA has the conventional architecture of a computer and in particular comprises a memory MEMI and a processing unit UTRI, which is for example equipped with a processor PROCI and controlled by the computer program PGI stored in the memory MEMI. The computer program PGI comprises instructions for performing the actions:
communicating with the avatar-control device DC,
learning the plurality of actions ACT1, ACT2, ACT3,
storing in a structured manner the various learned actions ACT1, ACT2, ACT3 in the knowledge base BC,
accessing the knowledge base BC,
determining the most relevant action in relation to the current context of the virtual environment EV1 (EV2, EV3 respectively).

On initialization, the code instructions of the computer program PGI are for example loaded into a RAM (not shown) before being executed by the processor PROCI. The processor PROCI of the processing unit UTRI in particular implements the aforementioned actions, according to the instructions of the computer program PGI.

The simplified structure of an artificial-intelligence module MIA′ used in the system for autonomously controlling an avatar according to the disclosed technology, and as shown in FIG. 1B, will now be described with reference to FIG. 3B.

Such a device MIA′ comprises:
a communication interface MCOI′ configured to receive, from the control device DC′, at least one request to select an action to be applied autonomously to the avatars AV_UT1′, AV_UT2′, AV_UT3′, and to send a response to this request,
a device DAP′ for learning a plurality of actions ACT1′, ACT2′, ACT3′ respectively executed by a given user or a plurality of different users, in the context of use of the smartphone payment service in a real environment ER′ or in a plurality of respective real environments ER1′, ER2′, ER3′, during an optionally predefined period of time,
a module MDG′ for digitally and/or graphically modelling the real environment ER′ or the respective real environments ER1′, ER2′, ER3′ and the actions ACT1′, ACT2′, ACT3′,
a knowledge base BC′ that is configured to store in a structured manner the various modeled actions ACTm1′, ACTm2′, ACTm3′ in association with an identifier ID′ of a single virtual environment EV′ resulting from the graphical and/or digital modeling of the real environment ER′ or with a plurality of identifiers ID1′, ID2′, ID3′ of a plurality of corresponding virtual environments EV1′, EV2′, EV3′ resulting from the graphical and/or digital modeling of the respective real environments ER1′, ER2′, ER3′,
an interface IAC′ for accessing the knowledge base BC′,
a computing device CALI′ that is configured to determine the most relevant action in relation to the current context of the virtual environment EV1′ (EV2′, EV3′ respectively), which is detected in the action-selection request received from the control device DC′.

Although in the example shown, the knowledge base BC′ is not contained in the artificial-intelligence module MIA′, it may be integrated into said module if it has sufficient hardware and software resources.

By way of non-exhaustive examples, the artificial-intelligence module MIA′ may be a neural network, be based on deep-learning technology, be based on statistical-learning technology, etc.

According to one particular embodiment of the disclosed technology, the actions executed by the artificial-intelligence module MIA′ are implemented by instructions of a computer program PGI′. To this end, the module MIA′ has the conventional architecture of a computer and in particular comprises a memory MEMI′ and a processing unit UTRI′, which is for example equipped with a processor PROCI′ and controlled by the computer program PGI′ stored in the memory MEMI′. The computer program PGI′ comprises instructions for performing the actions:
communicating with the avatar-control device DC′,
learning the plurality of actions ACT1′, ACT2′, ACT3′ in the real environment ER′ or in a plurality of different real environments ER1′, ER2′, ER3′,
digitally and/or graphically modeling the actions ACT1′, ACT2′, ACT3′,
storing in a structured manner the various digitally and/or graphically modeled actions ACTm1′, ACTm2′, ACTm3′ in the knowledge base BC′,
accessing the knowledge base BC′,
determining the most relevant action in relation to the current context of the virtual environment EV1′ (EV2′, EV3′ respectively).

On initialization, the code instructions of the computer program PGI′ are for example loaded into a RAM (not shown) before being executed by the processor PROCI′. The processor PROCI′ of the processing unit UTRI′ in particular implements the aforementioned actions, according to the instructions of the computer program PGI′.

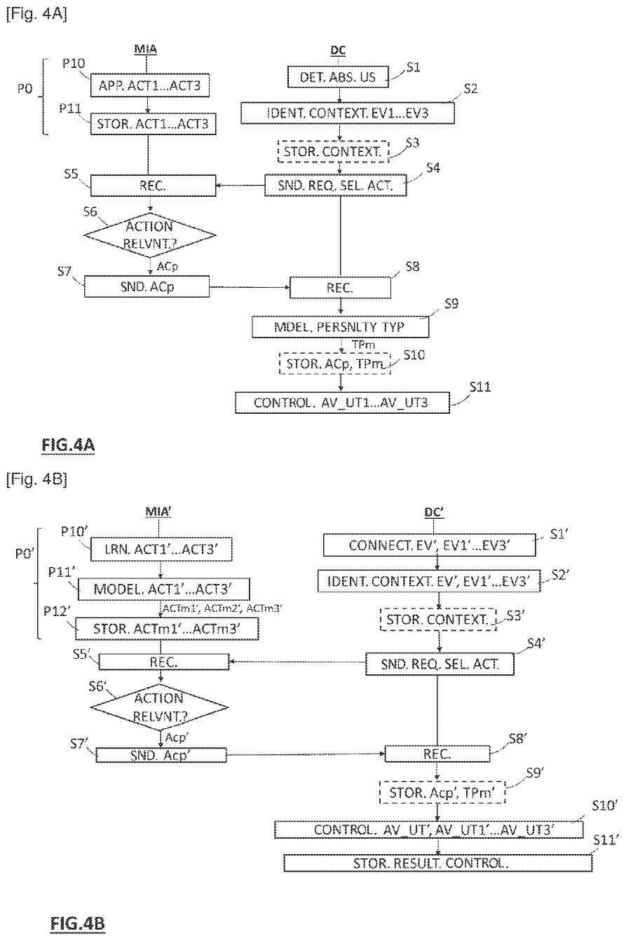

A description will now be given, with reference to FIG. 4A, together with FIGS. 1A, 2A and 3A, of a method for controlling an avatar, according to one particular embodiment of the disclosed technology.

In this embodiment, the avatar-control method is implemented by the control system shown in FIG. 1A, using the control device DC illustrated in FIG. 2A and the artificial-intelligence module MIA illustrated in FIG. 3A.

The avatar-control method illustrated in FIG. 4A comprises the following steps.

In a preliminary phase of learning configuration P0, the module MIA learns, in P10, via its module DAP, the aforementioned plurality of actions ACT1 (ACT2, ACT3 respectively) implemented by the avatar AV_UT1 (AV_UT2, AV_UT3 respectively) in its virtual environment EV1 (EV2, EV3 respectively), when this avatar is controlled or animated by a user using a human-machine interface.

This learning may occur as long as the user is still commanding or animating her or his avatar, or for a given period of time, for example a given day, a given week, a given semester, etc.

In this learning sub-phase P10, the device DAP learns the digital and/or graphical composition/structure of the virtual environment EV1 (EV2, EV3 respectively) and the type of actions/activities that the user has applied to her or his avatar using a human-machine interface, such as in particular:
a physical action of the avatar AV_UT1 (AV_UT2, AV_UT3 respectively),
an interaction of the avatar AV_UT1 (AV_UT2, AV_UT3 respectively) with a virtual object,
an interaction of the avatar AV_UT1 (AV_UT2, AV_UT3 respectively) with another avatar, for example AVU1 (AVU2, AVU3 respectively),
a particular personality type of the user of the avatar AV_UT1 (AV_UT2, AV_UT3 respectively).

With regard to the particular personality type, the device DAP in particular uses machine-learning techniques and various natural-language processing operations, in particular in the case where the virtual action or interaction executed is a written or oral communication. Such techniques may also be used to identify certain character traits of the user who is manipulating her or his avatar in each of the virtual environments EV1, EV2, EV3, in particular by exploiting certain digital traces generated by the user UT when the latter communicates using a communication terminal TC, for example, via e-mail, via SMS (acronym of Short Message Service), via videos, comments, etc. posted on social media, etc.

The device DAP of the module MIA may assign one or more personality types to the user based, for example, on the Big 5 model as described in the document: “Goldberg, L. R. (1981). Language and individual differences: The search for universals in personality lexicons. In Wheeler (ed.), Review of Personality and Social Psychology, Vol. 1, 141-165. Beverly Hills, CA: Sage”. This model describes personality using the following five main types:
openness: appreciation of art, of emotion, of adventure, of uncommon ideas, curiosity and imagination;
conscientiousness: self-discipline, dutiful, organization rather than spontaneity; goal-oriented;
extroversion: energy, positive emotions, tendency to seek stimulation and the company of others, go-getter;
agreeableness: tendency to be compassionate and cooperative rather than suspicious and antagonistic toward others;
neuroticism: tendency to easily experience unpleasant emotions such as anger, worry or depression.

After learning personality types based on this model, the device DAP will have evaluated the user five times differently, according to the five aforementioned types.

In practice, the device DAP assigns to the user a score for each of the five types (for example 1, 2, 3, 4, or 5). The personality of the user is therefore described by five different scores (a score relating to openness, a score relating to conscientiousness, a score relating to extroversion, a score relating to agreeableness and lastly a score relating to neuroticism). Thus, for example for the “extroversion” type, the user is assigned a score ranging from 1 to 5 depending on her or his level of extroversion, the minimum score 1/5 corresponding to a very introverted personality and the maximum score 5/5 corresponding to a very extroverted personality. This score assignment is implemented in the same way for the other four types.

After having learned physical actions ACT1 (ACT2, ACT3 respectively) of the avatar AV_UT1 (AV_UT2, AV_UT3 respectively), from interactions of the avatar AV_UT1 (AV_UT2, AV_UT3 respectively) with an object or another avatar, the device DAP detects the usual actions (e.g.: downloading content, telephoning, running, testing general knowledge, etc.) or reactions of the avatar in question (e.g.: running away in case of attack, retaliation against an aggressive other avatar, etc.), as well as the usual routes of this avatar through its corresponding virtual environment, via an analysis of the geolocation of the avatar AV_UT1 (AV_UT2, AV_UT3 respectively).

Once learning has occurred, in P11, the module MIA stores the plurality of learned actions ACT1, ACT2, ACT3 in the knowledge base BC, via the access interface IAC.

The plurality of actions ACT1, ACT2, ACT3 is stored in a structured manner in association with the corresponding avatar AV_UT1, AV_UT2, AV_UT3. To this end, the plurality of actions ACT1 (ACT2, ACT3 respectively) is stored in association with an identifier ID1 (ID2, ID3 respectively) of the virtual environment EV1 (EV2, EV3 respectively). More precisely, the plurality of actions ACT1 (ACT2, ACT3 respectively) is stored in a hierarchical manner in a decision tree in the form of a catalog of actions possible after the occurrence of a given event. In the case, for example, where the given event is an attack on the avatar by another avatar, a group of actions GA1 (GA2, GA3 respectively) of the plurality of actions ACT1 (ACT2, ACT3 respectively) comprises actions possible for the avatar AV_UT1 (AV_UT2, AV_UT3 respectively), such as, for example, running away, letting it happen, attacking its opponent, etc. These may be favorite actions, for example usual actions that the avatar takes in response to a particular event occurring in the virtual environment or actions deemed “laudable” of another avatar (e.g.: an avatar able to speak English fluently, an avatar always winning general-knowledge quizzes, an avatar that knows how to pass a driving test without making any mistakes, etc.). In the case where the usual actions of the avatar are routes regularly taken by the avatar in the virtual environment in question, location data relating to these routes are also stored in the knowledge base BC.

In one particular embodiment, a group of actions GA1 (GA2, GA3 respectively) may comprise a sequence of micro-actions that make up a particular action of the avatar AV_UT1 or of another avatar (AV_UT2, AV_UT3 respectively) (e.g. crouching, standing up, extending an arm, running a meter, turning the head to the right, etc.).

In another particular embodiment, a group of actions may comprise an action routine (sequence of actions) of the avatar AV_UT1 (AV_UT2, AV_UT3 respectively) or of another avatar, in the form of a bot.

At the end of the phase of learning configuration P0, the control device DC then implements the following.

In a step S1, the control device DC determines, via its module DAI, the absence of intervention by the user on her or his avatar AV_UT1 (AV_UT2, AV_UT3 respectively) via a human-machine interface.

In one particular embodiment, such a determination may be executed at a particular time parameterized by the user of the avatar, either directly in the control device DC or on a dedicated server. For example, the user may decide that at midnight, her or his avatar will be controlled autonomously by the device DC and indicate this time to the control device DC or to the dedicated server.

In another particular embodiment, such a determination may be executed following receipt by the control device DC of an explicit instruction from the user to autonomously control her or his avatar. Such an instruction comprises, for example, pressing a particular key of the control device, sending a voice command, writing a particular message, etc.

In yet another particular embodiment, such a determination may be executed following detection of immobility of the avatar at the end of a certain period of time.

In a step S2, the control device DC identifies, via its module IEP, the current context of the virtual environment in question EV1 (EV2, EV3 respectively). For example, the module IEP determines the identifier ID1 (ID2, ID3 respectively) associated with the virtual environment in question EV1 (EV2, EV3 respectively), the number of avatars and the objects present in the scene, their respective locations, etc.

All the data identified in S2 are optionally stored in S3 in the memory STO of the control device DC. Since step S3 is optional, it has been shown in dashed lines in FIG. 4A.

The advantage of such storage is that it for example allows certain anomalies that are liable to occur during selection and autonomous application of control of actions to the avatars AV_UT1, AV_UT2, AV_UT3 to be traced, so as to debug and/or update and/or enrich with new functionalities the game proposed in virtual environment EV1, the immersive visit proposed in virtual environment EV2, and the driving instruction proposed in virtual environment EV3, respectively. Such storage further allows, for example, dangers encountered by the avatars AV_UT1, AV_UT2, AV_UT3 in their respective virtual environments EV1, EV2, EV3 to be recorded.

In a step S4, the module SEL of the control device DC triggers sending of an action-selection request to the artificial-intelligence module MIA, via the communication interface MCO. For example, it may be an HTTP request (HTTP standing for Hypertext Transfer Protocol), an SQL request (SQL standing for Structured Query Language), an AJAX request (AJAX standing for Asynchronous Javascript And XML), etc.

Such a request contains the data identified in S2.

The module MIA receives this request in S5, via its communication module MCOI.

The device CALI then determines in S6 at least the most relevant action ACp among the plurality of actions ACT1 (ACT2, ACT3 respectively) in relation to the current context of the virtual environment EV1 (EV2, EV3 respectively) contained in the received request.

If a particular event has occurred in relation to the current context, such a relevant action ACp is selected in S6 from the group of actions GA1 (GA2, GA3 respectively), which group may contain one or more actions learned when an event similar to the one encountered in the current context occurred. Such a relevant action ACp may also be selected by way of favorite action from among the plurality of actions ACT1 (ACT2, ACT3 respectively). Such a relevant action ACp may also be randomly selected from the plurality of actions ACT1 (ACT2, ACT3 respectively).

In S7, the module MIA sends a response to the control device DC, via its communication module MCOI, the response containing the relevant action ACp computed by the computing device CALI. The response may also contain, in association with the relevant action ACp, at least one score assigned to at least one personality type of the user of the avatar AV_UT1 (AV_UT2, AV_UT3 respectively).

The control device DC receives this response in S8, via its communication module MCO.

In S9, if the received response contains one or more scores representative of one or more personality types, respectively, the module MDG of the control device DC models this or these scores digitally or graphically in the form, for example, of an icon TPm representative of this personality type (e.g.: the icon smiles if the user of the avatar is a calm person, the icon pouts if the user of the avatar is a reserved person, etc.), or of a modification TPm to be applied to the avatar AV_UT1 (AV_UT2, AV_UT3 respectively) depending on the personality trait corresponding thereto (e.g.: in the case of cheerfulness, the avatar smiles, in the case of stress, the avatar shakes, in the case of open-mindedness, the avatar opens its arms with a smile, etc.).

In S10, the relevant action ACp and the modeled personality type(s) TPm are optionally stored in the memory STO of the control device DC. Since step S10 is optional, it has been shown in dashed lines in FIG. 4A.

In S11, the control module CMD of the control device DC then applies the relevant action ACp to the avatar AV_UT1 (AV_UT2, AV_UT3 respectively), where appropriate in accordance with the modeled personality type(s) TPm.

Of course, the user of the avatars AV_UT1, AV_UT2, AV_UT3 may at any time retake control of the latter using the human-machine interface. In this case, steps S1 to S11 are not implemented and a new phase P0 of learning configuration is implemented so as to continue enrichment of the knowledge base BC with new actions applied to the avatars AV_UT1, AV_UT2, AV_UT3 by the user using the human-machine interface.

Resumption of control of the avatars by the user may take various forms.

In one particular embodiment, such a resumption may be executed at a particular time parameterized by the user of the avatar, either directly in the control device DC or on a dedicated server. For example, the user may decide that at eight o'clock in the morning, her or his avatar will be controlled by her or him and indicate this time to the control device DC or to the dedicated server.

In another particular embodiment, such a resumption may be executed following receipt by the control device DC of an explicit instruction from the user indicating that the latter would like to control her or his avatar using a human-machine interface. Such an instruction comprises, for example, pressing a particular key of the control device, sending a voice command, writing a particular message, etc.

In yet another particular embodiment, such a resumption may be executed following detection of actuation of the human-machine interface with a view to controlling the avatar.

A description will now be given, with reference to FIG. 4B, together with FIGS. 1B, 2B and 3B, of an avatar-control method according to another particular embodiment of the disclosed technology.

In this embodiment, the avatar-control method is implemented by the control system shown in FIG. 1B, using the control device DC′ illustrated in FIG. 2B and the artificial-intelligence module MIA′ illustrated in FIG. 3B.

The avatar-control method illustrated in FIG. 4B comprises the following steps.

In a preliminary phase of learning configuration P0′, the module MIA′ learns, in P10′, via its module DAP′, the aforementioned plurality of actions ACT1′ (ACT2′, ACT3′ respectively) implemented by one or more different users in a real-life situation, in a given real environment ER′ or in a plurality of respective real environments ER1′, ER2′, ER3′, when the user or the different users are using a data communication service, such as for example the aforementioned smartphone payment service.

This learning for example occurs for a given period of time, for example a given day, a given week, a given semester, etc.

In this learning sub-phase P10′, the device DAP′ learns the real composition/structure of the real environment ER′ or of the real environments ER1′, ER2′, ER3′, as well as the type of actions/activities that the user or users performed while using the service, such as for example:
a particular action of a given user, such as for example a particular movement (e.g.: moving her or his fingers to type a code, bending to pick up the object to be purchased, frowning, etc.),
an interaction of a given user with a real object, for example a smartphone or a product or service that the user intends to purchase,
an interaction of a given user with at least one other user, such as for example a salesperson, a customer or a security guard of the shop in which a real object is located, etc.,
a particular personality type of a given user UT′, for example a level of open-mindedness, a level of extroversion or a level of empathy, in particular by exploiting certain digital traces generated by the user UT′ when the latter communicates using a communication terminal TC′, for example, via e-mail, via SMS (acronym of Short Message Service), via videos, comments, etc. posted on social media, etc.
etc.

The learning device DAP′ is identical to the learning device DAP described above. For this reason, it will not be described further.

Once the learning has been carried out, in P11′, the module MDG′ for digitally and/or graphically modeling models digitally and/or graphically all the elements making up the real environment ER′ or the real environments ER1′, ER2′, ER3′, as well as the plurality of actions ACT1′, ACT2′, ACT3′ carried out. The plurality of modeled actions is denoted ACTm1′, ACTm2′, ACTm3′.

In the example of the smartphone payment service, the modeling relates not only to the user and/or users involved in this service, in the form of respective avatars AV_UT′ or AV_UT1′, AV_UT2′, AV_UT3′ respectively, or yet other avatars AVU′ or AVU1′, AVU2′, AVU3′, but also objects (smartphone, product or service, shop, etc.), the discussions had during the use of the service, the scene (a shopping mall, a neighborhood store, etc.) making up the real environment ER′ or each of the real environments ER1′, ER2′, ER3′.

In P12′, the module MIA′ stores the plurality of modeled actions ACTm1′, ACTm2′, ACTm3′ in the knowledge base BC′, via the access interface IAC′.

The plurality of actions ACTm1′, ACTm2′, ACTm3′ is stored in a structured manner in association with an identifier ID′ of a virtual environment EV′ digitally and/or graphically reproducing the real environment ER′ or an identifier ID1′ (ID2′, ID3′ respectively) of a virtual environment EV1′ (EV2′, EV3′ respectively) digitally and/or graphically reproducing the real environment ER1′ (ER2′, ER3′ respectively). More precisely, the plurality of actions ACTm1′ (ACTm2′, ACTm3′ respectively) is stored in a hierarchical manner in a decision tree in the form of a catalog of actions possible after the occurrence of a given event. In the case, for example, where the given event is consultation of a balance, a group of actions GA1′ (GA2′, GA3′ respectively) of the plurality of actions ACTm1′ (ACTm2′, ACTm3′ respectively) comprises actions possible for an avatar AV_UT′ of a user of the service in the virtual environment EV′ or an avatar AV_UT1′ (AV_UT2′, AV_UT3′ respectively) of a user of the service in the virtual environment EV1′ (EV2′, EV3′ respectively), such as buying a product or service if the balance is positive, contacting a bank advisor if the balance is negative, requesting credit from the merchant, etc. These may be favorite actions, for example usual actions that the avatar takes in response to a particular event occurring in the virtual environment or actions deemed “laudable” of another avatar (e.g.: an avatar that never makes a mistake entering the amount to pay, an avatar that is always calm when shopping, an avatar that uses the service often in the same place, etc.). In the case where the usual actions of the avatar are routes regularly taken by the avatar in the virtual environment in question, location data relating to these routes are also stored in the knowledge base BC′. These may also be non-favorite actions taken in relation to use of the service (e.g.: an avatar that gets annoyed because it is unable to correctly enter its secret code, a visually impaired avatar unable to use voice commands on its smartphone, etc.).

In one particular embodiment, a group of actions GA1′ (GA2′, GA3′ respectively) may comprise a sequence of micro-actions that make up a particular action of the avatar AV_UT′ or of the avatar AV_UT1′ (AV_UT2′, AV_UT3′ respectively) (e.g. crouching, standing up, extending an arm, turning the head to the right, reaching out a hand to input a secret code on the keyboard of the smartphone etc.).

In another particular embodiment, a group of actions may comprise an action routine (sequence of actions) of the avatar AV_UT′ or of the avatar AV_UT1′ (AV_UT2′, AV_UT3′ respectively) or even of another avatar, in the form of a bot.

The phase of learning configuration P0′ described above in particular allows a certain number of situations that may occur during use of the smartphone payment service, in real-life situations, to be simulated.

At the end of the phase of learning configuration P0′, the control device DC′ then implements the following.

In a step S1′, the control device DC′ connects to at least one virtual environment EV′ or, in parallel, to a plurality of virtual environments EV1′, EV2′, EV3′. The virtual staging played out in each of these virtual environments may, for example, correspond to a particular step of implementation of the smartphone payment service. For example, in each of the virtual environments EV1′, EV2′, EV3′, the step of entering on the smartphone the recipient of the payment by the avatar AV_UT1′, AV_UT2′, AV_UT3′, respectively, is simulated in three different ways, respectively. In another example, in each of the virtual environments EV1′, EV2′, EV3′, a different step of the smartphone payment service is simulated, for example:
the step of launching the application of the payment service on the smartphone, by the avatar AV_UT1′, in the virtual environment EV1′,
the step of identification on the application, for example via entry, by the avatar AV_UT2′, of an identifier and a password, in the virtual environment EV2′,
the step of selecting the type of banking operations (e.g. transfer of money, purchase, credit application, etc.) to be performed by the avatar AV_UT3′ in the virtual environment EV3′.

In one particular embodiment, such a connection may be executed at a particular time that has been set by a user wishing to test various possible configurations or one particular aspect of the smartphone payment service (e.g.: entering the secret code, sending an error message during the payment, etc.), this particular time having been set either directly in the control device DC′ or on a dedicated server. The user may for example decide that, on the last day of each month, the device DC′ will autonomously trigger virtual tests of the smartphone payment service, and indicate the date corresponding to this day to the control device DC′ or dedicated server.

In another particular embodiment, such a connection S1′ may be executed following receipt by the control device DC′ of an explicit instruction from the user to trigger tests of the service autonomously. Such an instruction comprises, for example, pressing a particular key of the control device, sending a voice command, writing a particular message, etc.

In a step S2′, the control device DC′ identifies, via its module IEP′, the current context of the virtual environment in question EV′ or EV1′ (EV2′, EV3′ respectively) to which it has connected. For example, the module IEP′ determines the identifier ID′ or ID1′ (ID2′, ID3′ respectively) associated with the virtual environment in question EV′ or EV1′ (EV2′, EV3′ respectively), the number of avatars and the objects present in the scene, their respective locations, etc.

All the data identified in S2′ are optionally stored in S3′ in the memory STO′ of the control device DC′. Since step S3′ is optional, it has been shown in dashed lines in FIG. 4B.

In a step S4′, the module SEL′ of the control device DC′ triggers sending of an action-selection request to the artificial-intelligence module MIA′, via the communication interface MCO′. For example, it may be an HTTP request, an SQL request, an AJAX request, etc.

Such a request contains the data identified in S2′.

The module MIA′ receives this request in S5′, via its communication module MCOI′.

The device CALI′ then determines in S6′ at least the most relevant action ACp′ among the plurality of actions ACT1′ (ACT2′, ACT3′ respectively) in relation to the current context of the virtual environment EV′ or EV1′ (EV2′, EV3′ respectively) contained in the received request.

If a particular event has occurred in relation to the current context, such a relevant action ACp′ is selected in S6′ from the group of actions GA1′ (GA2′, GA3′ respectively), which group may contain one or more actions learned on occurrence of an event already encountered in a real-life situation and similar to the one encountered in the current virtual context. Such a relevant action ACp′ may also be selected by way of favorite action from among the plurality of actions ACT1′ (ACT2′, ACT3′ respectively). Such a relevant action ACp′ may also be selected randomly from the plurality of actions ACT1′ (ACT2′, ACT3′ respectively) so as to test a behavior of the service that has not necessarily been encountered in a real-life situation.

In S7′, the module MIA′ sends a response to the control device DC′, via its communication module MCOI′, the response containing the relevant action ACp′ computed by the computing device CALI′. The response may also contain, in association with the relevant action ACp′, at least one personality type TPm′ of a user UT′ who has tested the service in a real-life situation, said type having been modeled in P11′.

The control device DC′ receives this response in S8′, via its communication module MCO′.

In S9′, the relevant action ACp′ and the modelled personality type(s) TPm′ are optionally stored in the memory STO′ of the control device DC′. Since step S9′ is optional, it has been shown in dashed lines in FIG. 4B.

In S10′, the control module CMD′ of the control device DC′ then autonomously applies the relevant action ACp′ to the avatar AV_UT′ or AV_UT1′ (AV_UT2′, AV_UT3′ respectively), where appropriate in accordance with the modeled personality type(s) TPm′.

In S11′, the result of this relevant action and the various modifications to the virtual environment engendered following application of this action are stored in the memory STO′ of the control device DC′. Such storage S11′ advantageously allows any error cases that did not occur in real-life situations to be recorded, this allowing corrective measures to be applied to the smartphone payment service, for example before deployment of such a service to the general public.

The autonomous control method that has just been described with reference to FIG. 4B is advantageously applicable in the context of validation of the design of a data communication service, such as the aforementioned smartphone payment service, as it allows a person in charge of carrying out validation tests on a service to easily and rapidly repeat a high number of sets of virtual tests, with various possible error cases. These sets of tests may be run autonomously in parallel, in a synchronized manner, in one virtual environment EV′ or a plurality of virtual environments EV1′, EV2′, EV3′.

In the step of learning configuration P0′, a user tests the payment service in a real-life situation. To this end, she or he does her or his shopping, for example at a market, and provides payment for her or his purchases to a merchant using her or his smartphone. The tester user will have previously installed a payment application on her or his smartphone and will have previously registered for the service.

Many steps of the service may be executed in phase P0′, such as the following steps for example:
1/ The tester user launches the payment-service application and identifies herself or himself on it, for example by entering an identifier and a password;
2/ The user selects in the application the payment service, from a list of services offered: transfer of money to a third-party account, credit application, etc.;
3/ The user enters the recipient of the payment she or he wishes to make, for example the merchant, for example by entering the mobile phone number of the merchant;
4/ The user enters the amount to be paid: a check is then carried out by the service to verify that the balance of the tester user's account is indeed higher than or equal to the amount to be paid, plus payment fees (for example, a fixed amount that is charged by the service operator on each payment operation). If the balance of the tester user's account is insufficient, a message is sent to the user via the application, asking her or him to fund her or his account from another bank account or indeed to apply for credit;
5/ The user enters her or his secret code, which code will have been previously defined by the user, for example when registering for the service;
6/ The payment is then made, then a message is sent to the user via the application, to confirm that her or his payment has indeed been made. In the event of a problem, for example a technical problem during payment, an error message is sent to the tester user, for example to inform her or him that the payment has not been made and to ask her or him to restart the payment.

All or some of these steps constitute the aforementioned actions ACT1′, ACT2′, ACT3′.

It should be noted that these successive steps required to make a smartphone payment may lead to many error cases. These error cases must be foreseen by the operator of the payment service during design of the service, then tested before deployment of the service, then tested again before deployment of each new version of the service (e.g.: evolution of the service). These regular testing campaigns (on each new version of the service) are time-consuming and expensive for the service operator because a number of testers must, in parallel, systematically reproduce all the identified error cases. Furthermore, there is also a risk that certain error cases will not be tested, quite simply because they were not foreseen.

Examples of error cases are listed below:
In step 1/ the user enters an incorrect password, possibly several times, this resulting in the service being blocked;
In step 3/ the user enters an erroneous payment recipient: for example a telephone number that does not have the correct format (too short or too long), the number entered does not correspond to any user (e.g.: number not assigned or corresponding to a user who has not subscribed to the smartphone payment service, etc.);
etc.

In one possible implementation of the phase of learning configuration P0′, a certain number of tester users are required, for example one hundred testers, who perform tests for a predetermined period of time, four weeks for example. These may for example be beta testers able to use the service during a test period, for example with a view to its official commercial launch.

Data relating to the actions ACT1′, ACT2′, ACT3′ implemented during use of the service by the testers, which actions are modeled in P1l′ and then stored in P12′, for example include:
the many aforementioned error cases encountered by the testers when using the service;
the movements of the testers (geolocation in the real environment),
the amounts paid for purchases made from merchants,
the time at which these purchases were made,
etc.

It will be noted that the panel of testers used is formed in such a way that, during the phase of learning configuration P0′, the testers generate a high number of error cases. For example, care is taken to ensure that these testers include people who generally have difficulty using digital tools (smartphones, etc.), people with disabilities (a visual impairment for example), etc. Specifically, it is assumed that testers having these particular profiles will produce/encounter error cases relatively frequently when using the service (probably more than a technician in charge of validating the service and trying to imagine every possible error case).

Implementation of steps S1′ to S11′ described above makes it possible for its part to test in N different ways, in N different virtual environments, N virtual versions of a given data communication service. Such tests are no longer performed by users (or testers) in real-life situations, but in a virtual environment EV′ or EV1′, EV2′, EV3′ that is a replica of the real environment in which the tests were performed in real-life situations (e.g.: replica of streets, markets, merchants, etc.) in the aforementioned phase of learning configuration P0′. In each of these virtual environments, at least one avatar possesses a behavior that the tester had in a real-life situation (e.g., movements through the streets of the town, through markets, purchases made from merchants through mobile payments, etc.) and that was modeled by the module MDG′ of the artificial-intelligence module MIA′ during the aforementioned phase of learning configuration P0′. Thus, by virtue of the disclosed technology, in each of the aforementioned virtual environments, avatars will reproduce the error cases to be tested, autonomously, without any human intervention. Computer records (digital traces) obtained in S11′ make it possible to record any problems encountered in these virtual environments by avatars during their purchases (e.g.: an avatar tried several times, without success, to pay a merchant, or an avatar blocked its account after entering several incorrect passwords during its identification and never managed to reset its password, etc.). An operator will thus be able to analyze these traces after the event and thus detect, and then correct, any software anomalies in the payment service. It will also be possible to improve the service, for example to enrich it with new functionalities, by virtue of analysis of the behavior of the avatars (e.g.: if it appears that it is very common—in a market for example—for avatars to make several payments in a relatively short window—for example fifteen minutes—the operator might choose, in a future version of the service, to ask the user to identify herself or himself at most every fifteen minutes, and not on each payment, in order to make it easier for the user to use the service).

What is claimed is:

1. A method for controlling an avatar in a virtual environment, wherein in the absence of human intervention to animate the avatar via a control interface, the method comprising, in a control device, triggering at least one action of the avatar in the virtual environment, said at least one action being selected:
among a first plurality of actions learned beforehand during a period of time in which the avatar or another avatar was animated by at least one user in said virtual environment, via a control interface, or
among a second plurality of actions digitally modeled based on learning actions executed by at least one user in a real environment corresponding to the virtual environment.

2. The method of claim 1, wherein:
said first plurality of actions comprises a type of movement of the avatar or other avatar, or an interaction of the avatar or other avatar with an object or with a further avatar, or a manifestation of a personality type of the user of the avatar or other avatar, or
said second plurality of actions comprises actions taken during use, by at least one user, of a data communication service.

3. The method of claim 2, wherein the personality type of the user is identified based on at least one message generated by the user via at least one communication terminal.

4. The method of claim 1, additionally comprising digitally recording accomplishment of said at least one triggered action of the avatar.

5. The method of claim 1, wherein when said at least one action of the avatar is triggered in relation to an event that occurred in the virtual environment, said at least one action is selected:
from a first group of actions of the first plurality of actions, the actions of said first group of actions having already been executed in relation to an event similar to the event that occurred, or
from a second group of actions of the second plurality of actions, the actions of said second group resulting from digital modeling of actions executed in a real environment in relation to an event similar to the event that occurred.

6. The method of claim 1, wherein said at least one selected action is an action, of the first plurality of actions or second plurality of actions respectively, that has been identified beforehand as a favorite action.

7. The method of claim 1, wherein said at least one action is randomly selected among the first plurality of actions or second plurality of actions respectively.

8. A device for controlling an avatar in a virtual environment, the device configured to trigger, in the absence of human intervention to animate the avatar via a control interface, at least one action of the avatar in the virtual environment, said at least one action being selected:
among a first plurality of actions learned beforehand during a period of time in which the avatar or another avatar was animated by at least one user in said virtual environment, via a control interface, or
among a second plurality of actions digitally modeled based on learning actions executed by at least one user in a real environment corresponding to the virtual environment.

9. A non-transitory computer-readable data medium having stored thereon instructions which, when executed by a processor, cause the processor to implement the method of claim 1.
